(19) United States
(12) Patent Application Publication
(10) Pub. No.: US 2013/0288830 A1
(43) Pub. Date: Oct. 31, 2013

(54) STRUCTURALLY MODIFIED BAT FOR SPORTS, INCLUDING METHODS OF PRODUCTION

(71) Applicant: Mark Kreindler, Danville, CA (US)

(72) Inventor: Mark Kreindler, Danville, CA (US)

(21) Appl. No.: 13/870,478

(22) Filed: Apr. 25, 2013

Related U.S. Application Data
(60) Provisional application No. 61/638,331, filed on Apr. 25, 2012.

(51) Int. Cl. A63B 59/06; B32B 37/16

(52) U.S. Cl. CPC A63B 59/06; B32B 37/16
USPC 473/564; 156/60

(57) ABSTRACT

Bats and methods for producing a bat for use in sports are describe and include providing a bat comprising a natural or synthetic material and having a handle portion, a barrel portion and a head portion, providing a multi-component film, applying at least one layer of the multi-component film to at least part of the handle portion of the bat, the barrel portion of the bat or a combination thereof, providing a releasable textured layer, applying the releasable textured layer to the handle portion of the bat, the barrel portion of the bat or a combination thereof, curing the bat at a temperature that is compatible with the multi-component film.

This United States patent application claims priority to U.S. Provisional Patent Application No. 61/638,331 filed on Apr. 25, 2012 and entitled “Structurally Modified Bat for Sports, Including Methods of Production”, which is commonly-owned and incorporated herein by reference in its entirety.

### FIELD OF THE SUBJECT MATTER

The field of the subject matter is structurally modified bats for sporting activities and their methods of production.

### BACKGROUND

Bats are used in several different sports, such as baseball, softball and cricket, to make contact with and direct a ball. In these sports, there are several design considerations, some of them competing with one another. For example, the handle should be able to be easily held and provide control for the user to control the bat head, the bat head should be as big as possible, the bat should be as light and balanced as possible, and the bat should be durable and of professional grade wood. Other considerations include the measurements prescribed by the related sports association, such as Major League Baseball, and ensuring that the professional grade billet is matched with the specifications of the bat model that it is going to be made in to.

There have been several patents that try and correct some of the deficiencies of conventional bats. U.S. Pat. No. 8,066,594 entitled “Baseball Bat” utilizes different materials to actually build up the bat and/or portions of the bat. For example, the head portion of the bat may be wood and the handle portion of the bat may be composite material or built up in layers that include KEVLAR® and NYLON®. The portions of the bat are not wrapped or further strengthened beyond the materials used to form or build up the head and/or handle of the bat. U.S. Pat. No. 6,945,886 entitled “Bat with Composite Handle” is very similar, in that the handle is built up using multiple composite layers of materials.

US Patent Publication No.: 2009/0325738 entitled “Baseball Bat” discloses a baseball bat that has a sleeve that surrounds a portion of the bat. The sleeve is specifically designed to be removable, to stretch and to help prevent scattering of splinters and wood projectiles if the bat shatters during use. While this sleeve may serve the purpose of containing splinters, it does not provide a strengthening component to the handle or other vulnerable portions of the bat.

U.S. Pat. No. 6,036,610 entitled “Reinforced Baseball Bat” discloses a baseball bat that has a reinforced handle portion and an enhanced gripping surface. The invention includes a biaxially braided tubular overlay member that is formed of carbon fibers and aramid fibers that is then laminated to the handle portion of the bat.

This process uses a thermosetting resin to laminate the overlay member to the bat, which is then cured to form the reinforced bat. There are several problems with these reinforced bats that can cause issues during use. First, the handle surface is textured by the overlay and not by any additional process directed specifically to tailoring a gripping or roughened surface. A resin has to be applied to the bat in a separate step, which can lead to an unrefined surface, leakage or other additional processing steps. The bat is cured over a period of 10-15 minutes, which may lead to quick cure problems during later use of the bat, such as cracking and peeling.

Based on the conventional sports bats and their production methods, it would be ideal to develop a process for streamlining the production of strengthened bats, while at the same time making the bats stronger and safer for use in the field.

### SUMMARY OF THE SUBJECT MATTER

Bats and methods for producing a bat for use in sports are describe and include providing a bat comprising a natural or synthetic material and having a handle portion, a barrel portion and a head portion, providing a multi-component film, applying at least one layer of the multi-component film to at least part of the handle portion of the bat, the barrel portion of the bat or a combination thereof, providing a releasable textured layer, applying the releasable textured layer to the handle portion of the bat, the barrel portion of the bat or a combination thereof, curing the bat at a temperature that is compatible with the multi-component film.

### BRIEF DESCRIPTION OF THE FIGURES

FIG. 1 shows a contemplated method of producing a bat used for sports.

FIG. 2 shows a standard baseball bat, as used in contemplated embodiments.

FIG. 3 shows a modified baseball bat, as used in contemplated embodiments.

FIG. 4 shows a modified baseball bat, as used in contemplated embodiments.

FIG. 5 shows a modified baseball bat, as used in contemplated embodiments.

FIG. 6 shows the raw testing data in graph form for NP1.

FIG. 7 shows the raw testing data in graph form for NP2.

FIG. 8 shows the raw testing data in graph form for NP3.

FIG. 9 shows the raw testing data in graph form for HP1.

FIG. 10 shows the raw testing data in graph form for HP2.

FIG. 11 shows the raw testing data in graph form for HP3.

FIG. 12 shows the raw testing data in graph form for MF1.

FIG. 13 shows the raw testing data in graph form for MF2.

FIG. 14 shows the raw testing data in graph form for MF3.

### DETAILED DESCRIPTION

As will be disclosed herein, a sports bat and related manufacturing process has been developed that addresses the goals outlined earlier, along with providing significant advancements over the conventional art.

Generally, contemplated sports bats are generally wooden or composite materials that have a biaxial braid of carbon fiber/aramid fiber in an epoxy matrix that surrounds at least the handle of the bat. The bias of the fibers is applied at about 20-70 degrees with respect to the longitudinal axis of the bat, and in some contemplated embodiments is applied approximately 45 degrees from or with respect to the longitudinal axis of the bat. The epoxy matrix is pre-impregnated in the material that contains the fibers and multiple layers of the materials are applied in order to increase both stiffness of the handle area and overall performance of the bat.

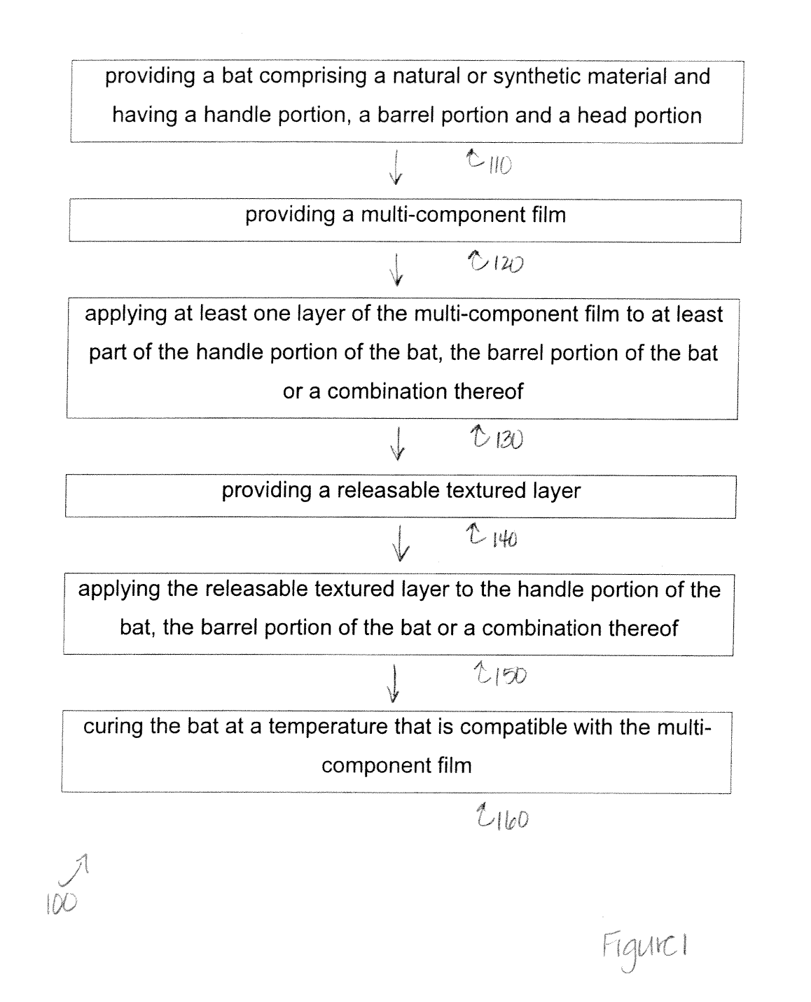

Specifically and as shown in FIG. 1, a method for producing a bat for use in sports 100 comprises: providing 110 a bat comprising a natural or synthetic material and having a handle portion, a barrel portion and a head portion, providing 120 a multi-component film, applying 130 at least one layer of the multi-component film to at least part of the handle portion of the bat, the barrel portion of the bat or a combination thereof, providing 140 a releasable textured layer, applying 150 the releasable textured layer to the handle portion of the bat, the barrel portion of the bat or a combination thereof, curing 160 the bat at a temperature that is compatible with the multi-component film. In additional methods, a releasable heat resistant tape or film may be applied to the releasable textured layer before curing in order to protect it, the bat or a combination thereof during curing.

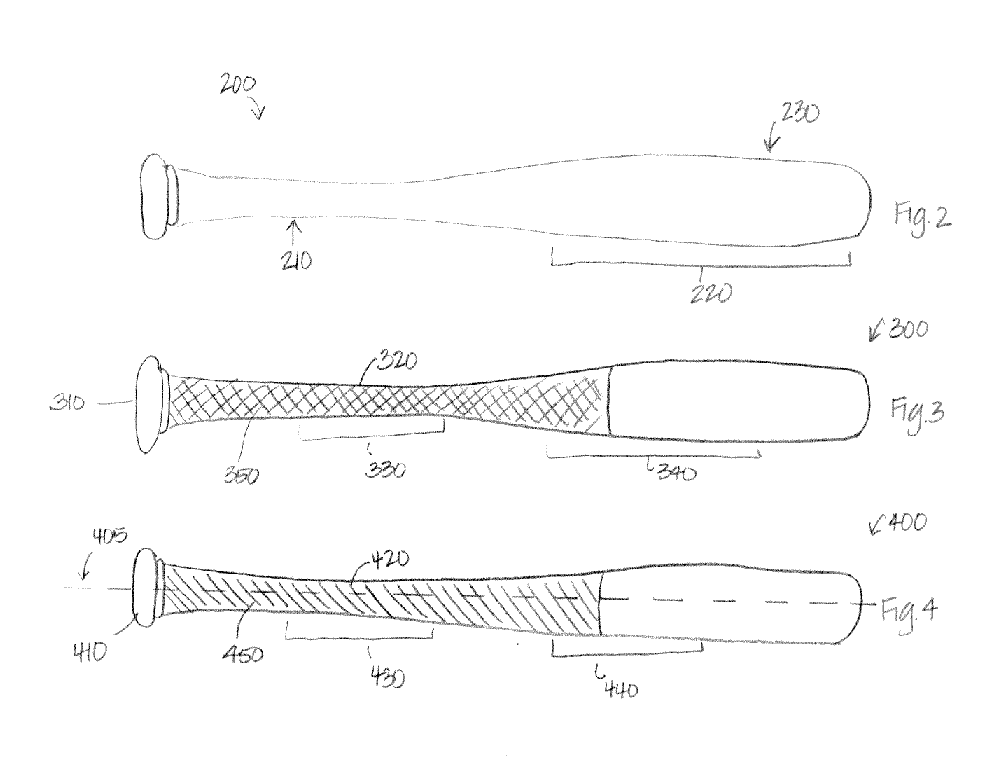

The bats that are produced using these contemplated methods are also contemplated. Contemplated natural or synthetic bat materials comprise wood or composite materials. As indicated, FIG. 2 shows a conventional bat 200 having a handle portion 210, a barrel portion 220 and a head portion 230.

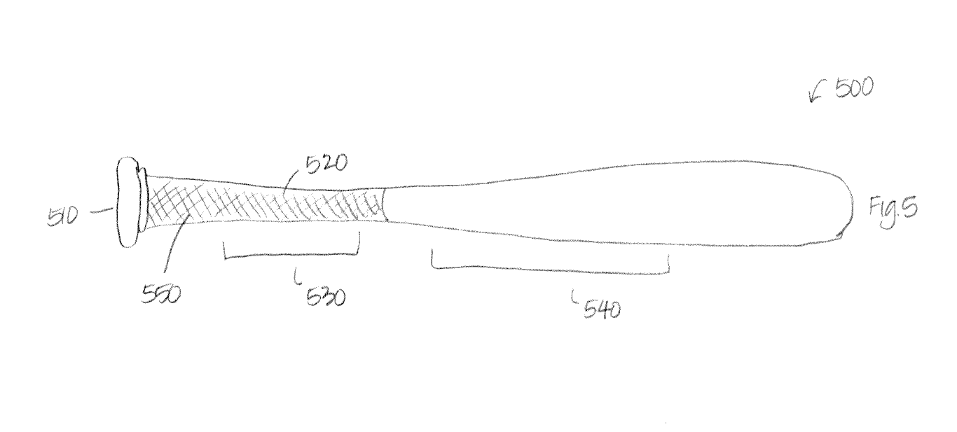

A contemplated bat 300 is shown in FIG. 3, where a bat 310 has a multi-component film 320 that is applied to at least part of the handle portion 330 and part of the barrel portion 340 of the bat 310. The multi-component film 320 in this Figure shows a contemplated biaxial braid material of fibers 350.

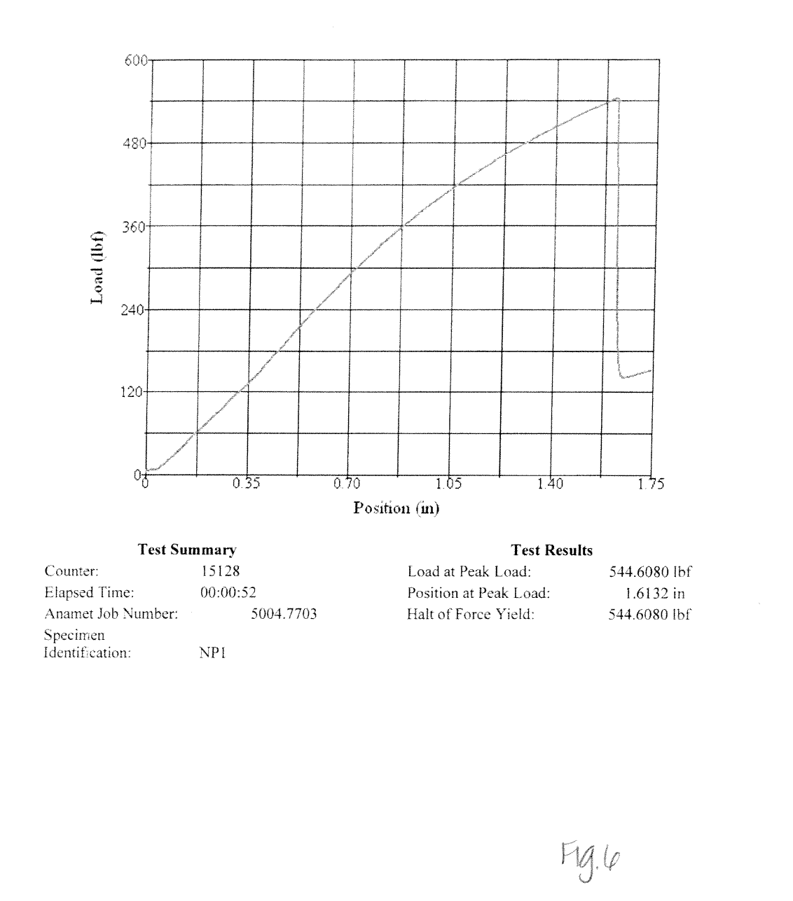

A contemplated bat 400 is shown in FIG. 4, where a bat 410 has a multi-component film 420 that is applied to at least part of the handle portion 430 and part of the barrel portion 440 of the bat 410. The multi-component film 420 in this Figure shows a contemplated plurality of fibers 450 at approximately a 45 degree angle from the longitudinal axis 405 of the bat 410.

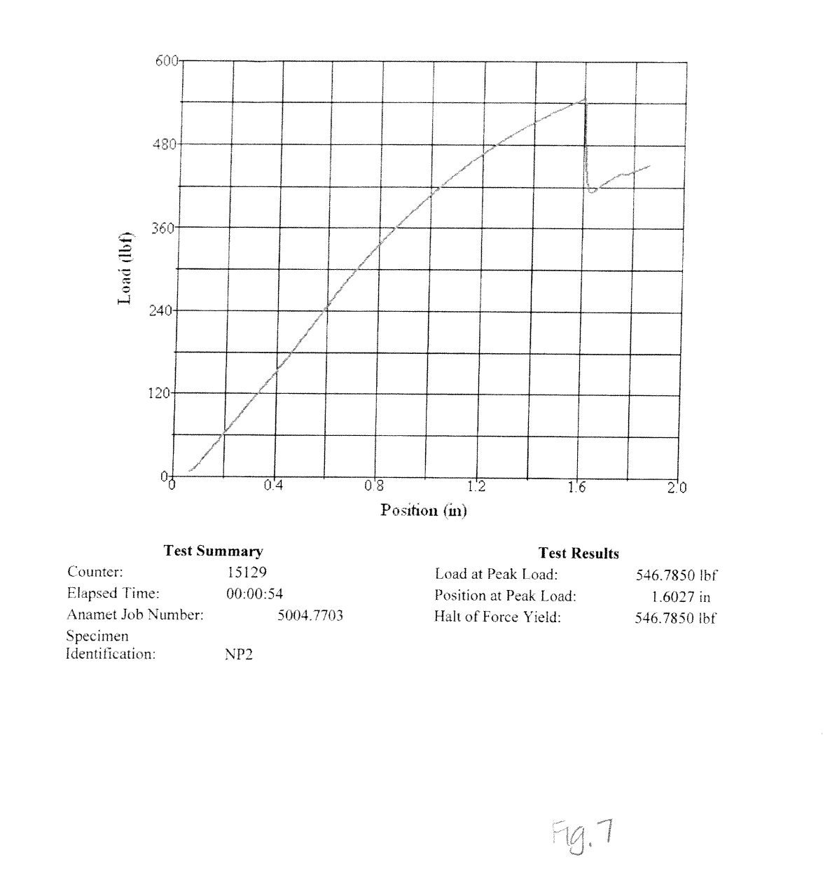

A contemplated bat 500 is shown in FIG. 5, where a bat 510 has a multi-component film 520 that is applied to at least part of the handle portion 530 and not part of the barrel portion 540 of the bat 510. The multi-component film 520 in this Figure shows a contemplated biaxial braid material of fibers 550.

The difference over conventional sports bats is shown in the method of production of contemplated embodiments. In contemplated embodiments, an approximate biaxial braid material is pulled or wrapped over the bat handle area extending from the knob, or end of the bat, upwards of about 18″ along the barrel in some embodiments, but may extend to various lengths depending on the bat and desired use of the bat. Multiple plies could be pulled or wrapped onto the bat as required by performance needs. As multiple layers are applied, the fibers could be adjusted to layer directly over one another or layer over one another so that the fibers are not lined up with one another from layer to layer.

In contemplated embodiments, a textured or roughened release fabric layer, which is some embodiments would comprise NYLON®, would be applied to the uncured material to provide a textured surface after curing. Release coated heat-shrink plastic tape could be hand or mechanically spiral-wound over the composite material and release layer and secured at each end using heat resistant tape.

Contemplated bats would then be cured in any type of suitable oven, including a non-pressurized composite oven at 250-260° F. for a suitable amount of time, which can be about 2 hours, to cause the tape to shrink and apply pressure to the composite on the bat handle. It is understood that cure temperatures, time and conditions may change based on the multi-component film. For example, if a different resin material is used, the cure temperature may be increased or decreased. The cure temperatures are tailored to the multi-component film and are suitable for the components in the film.

The cure cycle would also cause the epoxy to harden within the composite, bonding the composite fabric to the bat handle area. The plastic heat shrink tape and roughened surface nylon are removed prior to cosmetic touch up finishing.

This new process would address many of the shortcomings of conventional bats and the prior art in order to produce a sports bat that is durable, provides strength and stiffness for the user, while at the same time remaining within the rules and regulations of the various college and professional sports.

### EXAMPLES

### Example

### Comparison Load Testing for Baseball Bat

Three lots of bats were submitted for mechanical testing. The samples were identified as cut and sanded (NP), cut, sanded and oven cured (HP), and cut, sanded, oven cured and wrapped with a contemplated multi-component film according to contemplated methods (MF).

| Sample ID | | Load (lbs) |
|---|---|---|
| NP1 | | 545 |
| NP2 | | 547 |
| NP3 | | 530 |
| | Average | 541 |
| HP1 | | 499 |
| HP2 | | 541 |
| HP3 | | 608 |
| | Average | 549 |
| MF1 | | 754 |
| MF2 | | 616 |
| MF3 | | 718 |
| | Average | 696 |

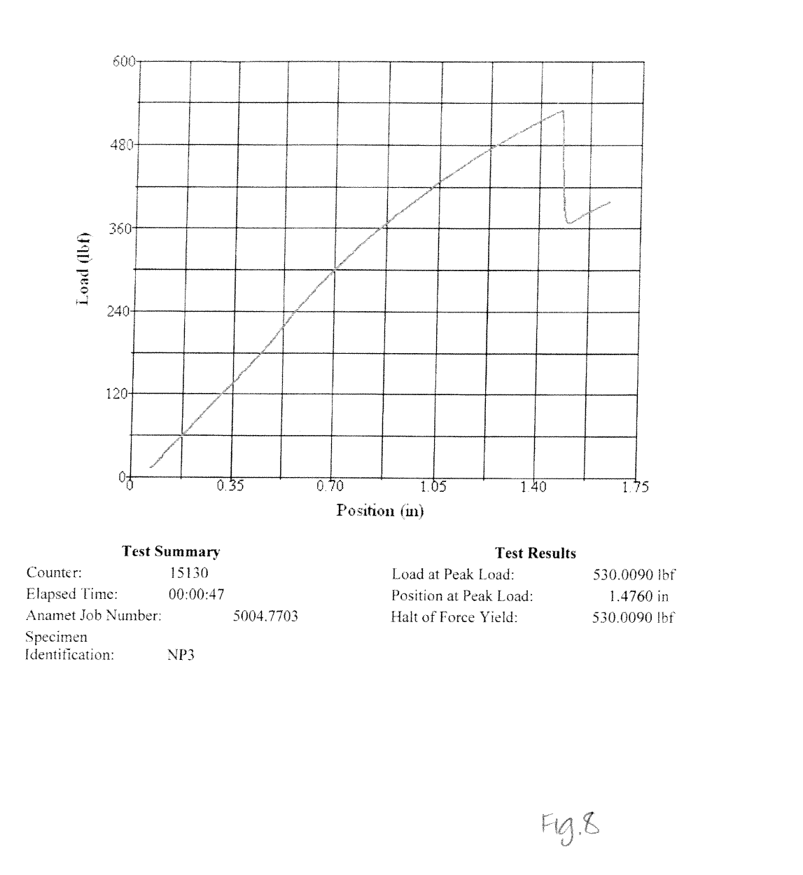

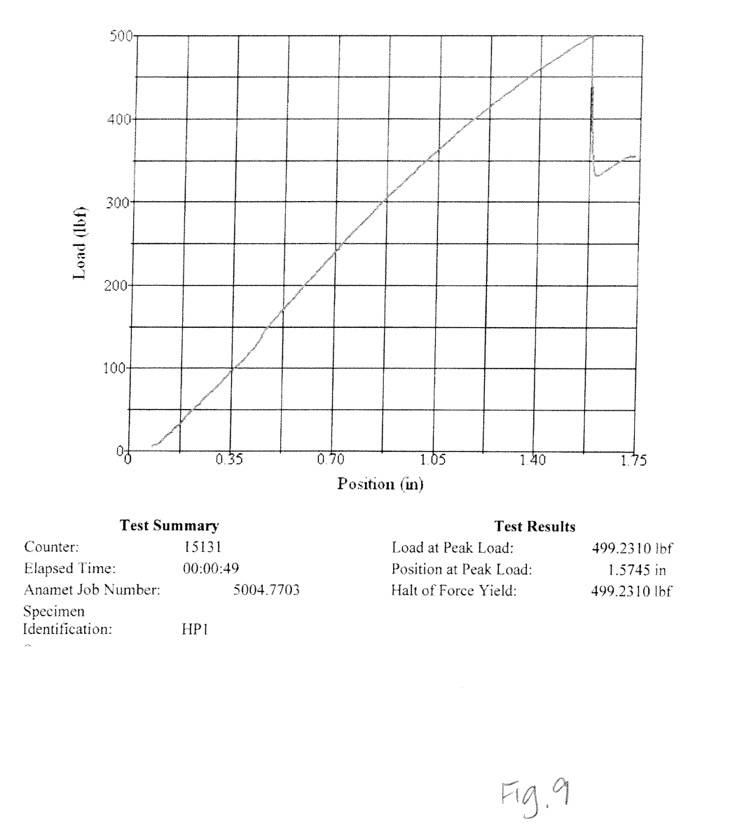

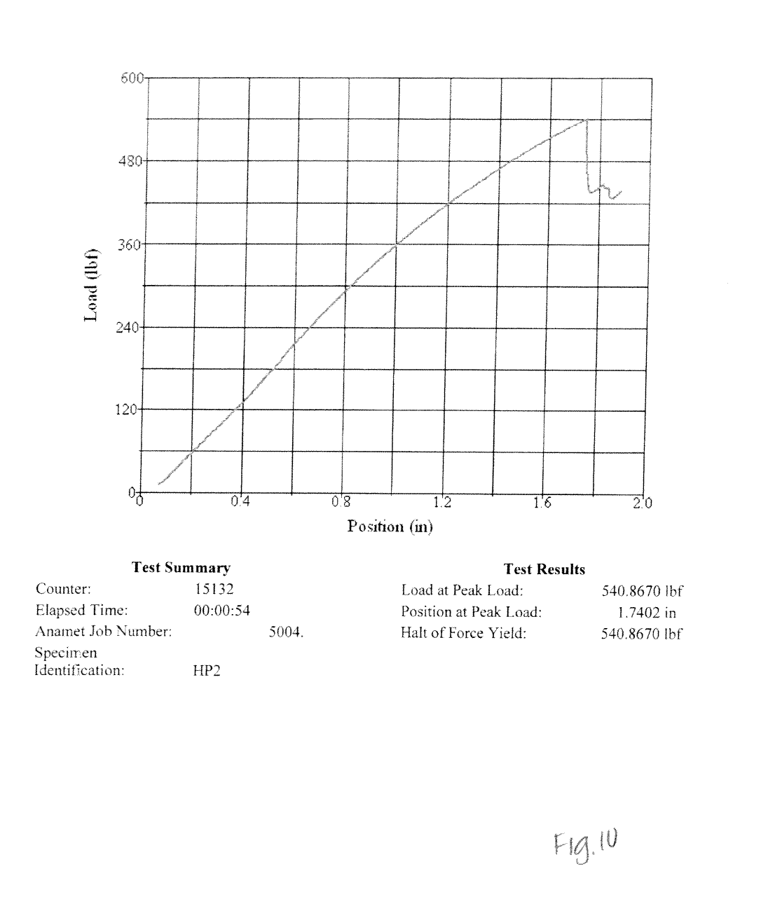

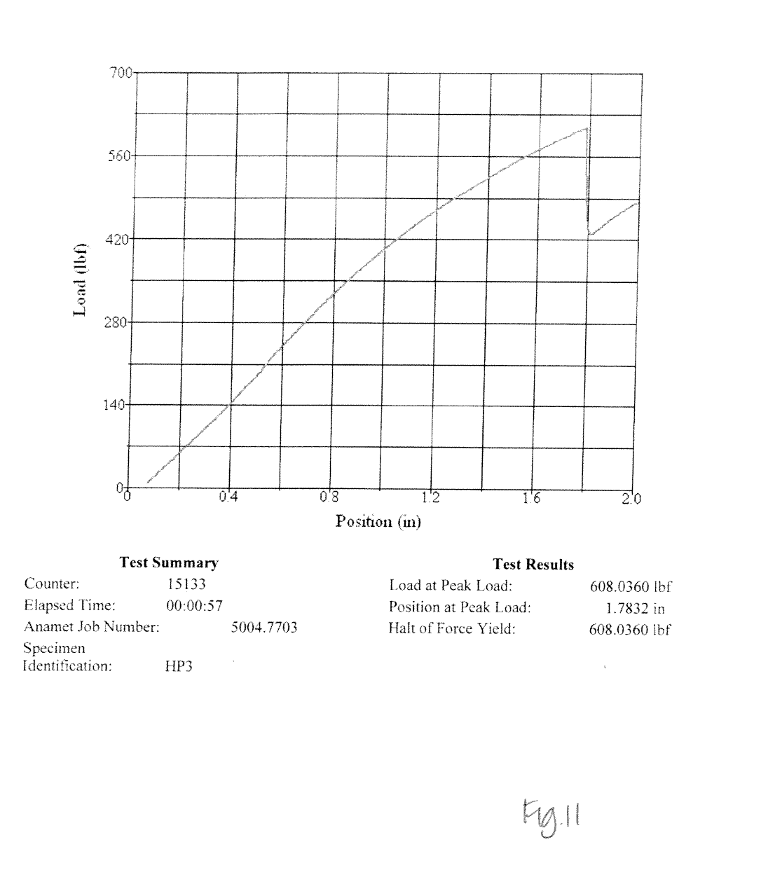

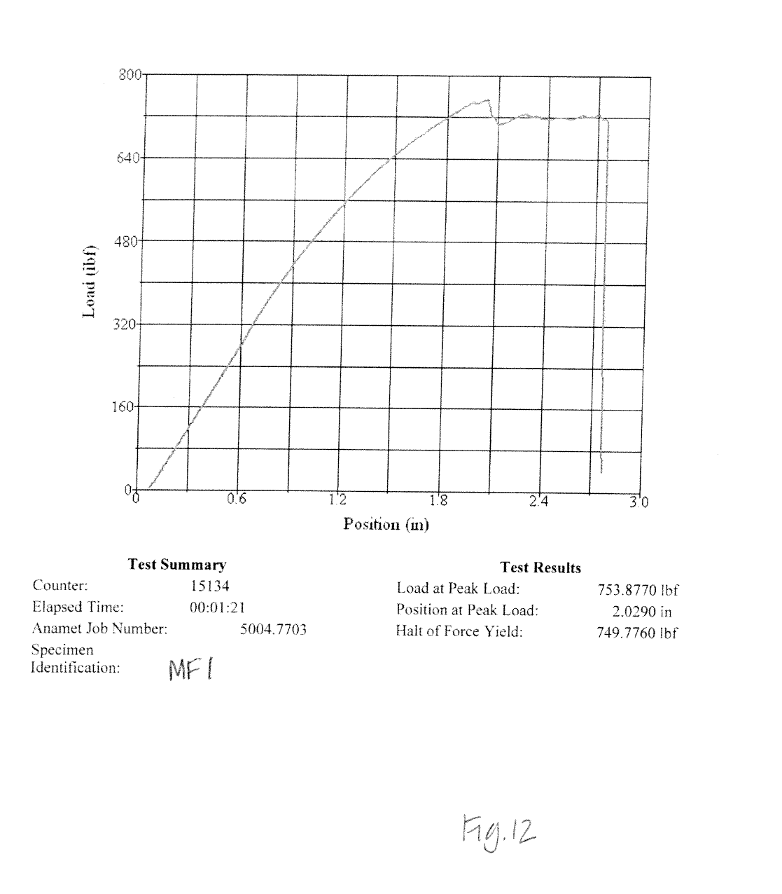

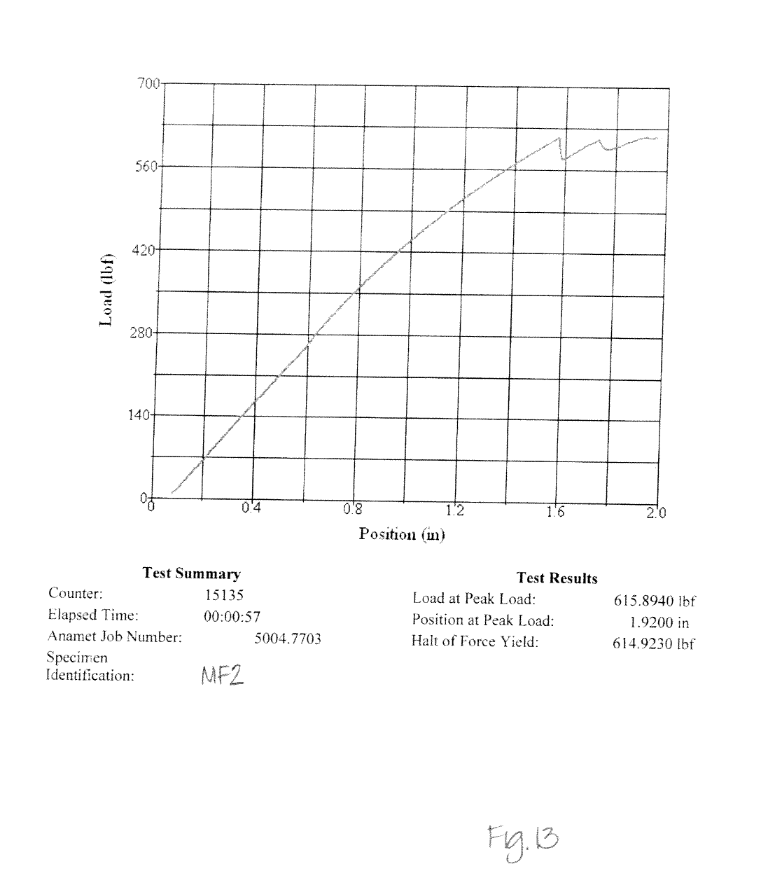

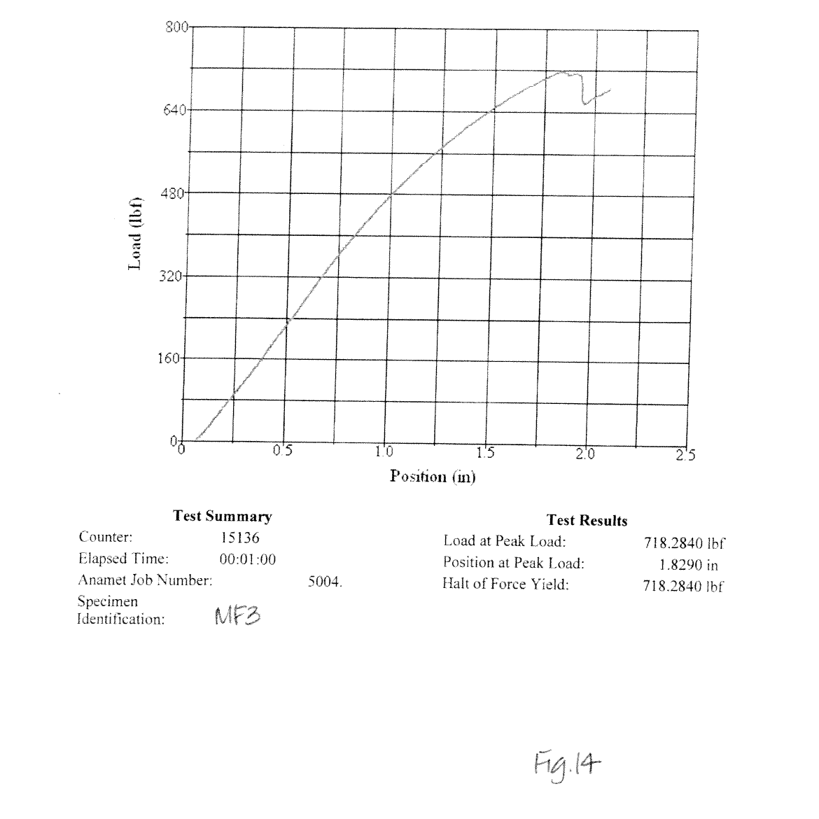

FIGS. 6-14 show the raw data results of each test above in graph form.

Thus, specific embodiments related to structurally-modified bats for sports, including methods of production have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method for producing a bat for use in sports comprising:
providing a bat comprising a natural or synthetic material and having a handle portion, a barrel portion and a head portion,
providing a multi-component film,
applying at least one layer of the multi-component film to at least part of the handle portion of the bat, the barrel portion of the bat or a combination thereof,
providing a releasable textured layer,
applying the releasable textured layer to the handle portion of the bat, the barrel portion of the bat or a combination thereof,
curing the bat at a temperature that is compatible with the multi-component film.

2. The method of claim 1, wherein applying the releasable textured layer to the handle portion of the bat, the barrel portion of the bat or a combination thereof, comprises applying the textured layer over the layer of multi-component film.

3. The method of claim 1, wherein the multi-component film comprises at least one fiber and at least one resin material.

4. The method of claim 1, wherein the multi-component film comprises a plurality of fibers and at least one resin material.

5. The method of claim 4, wherein the fibers comprise carbon fiber, aramid fiber or a combination thereof.

6. The method of claim 3, wherein the multi-component film comprises a biaxial braid material.

7. The method of claim 3, wherein at least one fiber comprises a bias.

8. The method of claim 7, wherein the bias is approximately 45 degrees from the longitudinal axis of the bat.

9. The method of one of claim 3 or 4, wherein the at least one resin material comprises a thermosetting resin.

10. The method of one of claim 3 or 4, wherein the at least one resin material comprises an epoxy resin.

11. The method of claim 1, further comprising applying a releasable heat resistant tape over the releasable textured layer, the bat or a combination thereof before the curing step.

12. A bat produced using the method of claim 1.
